(19) United States
(12) Patent Application Publication
(10) Pub. No.: US 2009/0008587 A1
(43) Pub. Date: Jan. 8, 2009

(54) Solenoid Valve

(76) Inventors: Harald Speer, Freiberg (DE); Dietmar Kratzer, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/162,155

(22) PCT Filed: Dec. 1, 2006
(86) PCT No.: PCT/EP2006/069226

§ 371 Date: Jul. 25, 2008

(30) Foreign Application Priority Data
Jan. 27, 2006 (DE) 102006003857.6

(51) Int. Cl. F16K 31/06

(52) U.S. Cl. 251/129.15

(57) ABSTRACT

The invention relates to a solenoid valve having a valve insert and a tappet which is movably guided in the valve insert by a tappet guide. The tappet is supported on a valve element by a restoring spring. According to the invention a centering element is arranged on the valve insert in the region of the restoring spring in such a way that the restoring spring is centered and stabilized.

### PRIOR ART

The invention relates to a solenoid valve according to the preamble to the independent claim 1.

FIG. 7 shows a conventional solenoid valve, in particular for a hydraulic unit, which is used, for example, in an antilock brake system (ABS), a traction control system (TCS), or an electronic stability program system (ESP system). As is clear from FIG. 7, in addition to a magnet assembly that is not shown here, the conventional solenoid valve 100, which is open when without current, has a valve cartridge that includes a capsule 106, a valve insert 101, a tappet 102, a return spring 103, and an armature 107. During the manufacture of the solenoid valve 100, the capsule 106 and the valve insert 101 of the valve cartridge are joined to each other by press-fitting and a sealing weld 108 seals the valve cartridge hydraulically in relation to the atmosphere. In addition, the valve insert 101 absorbs the compressive forces occurring in the hydraulic system and transmits them via a caulking flange 109 to a caulking region, not shown, on a fluid block. In addition, the valve insert 101 accommodates the so-called valve member 104, which includes a valve seat 110 into which the tappet 102 plunges in a sealed fashion in order to perform the sealing function of the solenoid valve 100. As is also clear from FIG. 7, the tappet 102 and the return spring 103 are guided in the valve insert 101, with the tappet 10 to being guided in a tappet guide 111 and the return spring 103 being guided radially and centered on the tappet 102 at one end while its other end rests against the valve member 104 in an axially guided fashion. The flow direction of the fluid through the solenoid valve is schematically depicted by a sequence of arrows 105. Consequently, the spring force of the return spring 103 acts in the region of the flow forces that act on the coils of the return spring 103 due to the flow. As a result, the flow can have an undesirable influence on the spring behavior. For example, the return spring 103 may lift away from its support against the valve member 104, which can be accompanied by a corresponding (force) exertion on the valve tappet 102 and an undesirable influence on the valve function.

### ADVANTAGES OF THE INVENTION

The solenoid valve according to the invention, with the defining characteristics of the independent claim 1, has the advantage over the prior art that a centering means is provided, which is situated on a valve insert in the vicinity of a return spring so that the return spring is centered and stabilized. As a result, it is advantageously possible to prevent flow forces that act on the coils of the return spring from being able to cause the return spring to break out laterally and to prevent the return spring from being able to lift away from a support as well as to prevent the coils of the return spring from being able to be set into motion or oscillation in relation to one another. In particular, the centering means centers and stabilizes a spring end that only rests axially against the valve member, without negatively influencing the ability of the solenoid valve to be assembled and adjusted.

Advantageous improvements of the solenoid valve disclosed in the independent claim are possible by means of the steps and modifications disclosed in the dependent claims.

It is particularly advantageous that the centering means includes at least one axially extending centering rib, which is situated in an internal bore of the valve insert. The at least one centering rib makes it possible to guide the return spring, for example, over a longer distance so that the return spring is advantageously centered and stabilized over virtually the entire length.

In one embodiment of the solenoid valve according to the invention, the at least one axial centering rib has a guide groove that is adapted to the diameter of the return spring and whose cross-sectional form preferably corresponds to a segment of a circle. Alternatively, the guidance of the centering rib can also be embodied in the form of a secant, i.e. as a straight segment. The form of the guide groove that is adapted to the return spring advantageously makes it possible to further improve the guidance of the return spring.

The centering means can, for example, be formed out of the material of the valve insert, i.e. can be embodied as integrally joined to the valve insert. The valve insert with the centering means can, for example, be manufactured as a turned part or as a cold forged part.

In another embodiment of the solenoid valve according to the invention, in order to center the return spring, the centering means of the valve insert has three axially extending centering ribs that are preferably spaced apart from one another by an average of 120°. This advantageously permits a more precise centering of the return spring during assembly. In addition, the centering means can have an assembly-assisting insertion bevel, thus facilitating assembly. For example, the centering means is situated so that an underside of the centering means is always spaced apart from the valve member in order not to present a stop for the valve member during an assembly process.

### DRAWINGS

The drawings show advantageous embodiments of the invention described below, as well as the conventional exemplary embodiment explained above for the sake of better comprehension of these embodiments.

FIG. 1 is a schematic sectional depiction of a solenoid valve according to the invention,

FIG. 2 is a schematic cross-sectional depiction along a line A-A from FIG. 1 to show a first embodiment of a valve insert,

FIG. 3 is a schematic perspective depiction of a second embodiment of the valve insert,

FIG. 4 is a schematic top view of the second embodiment of the valve insert according to FIG. 3,

FIG. 5 is a schematic perspective depiction of a third embodiment of the valve insert,

FIG. 6 is a schematic top view of the third embodiment of the valve insert according to FIG. 5, and

FIG. 7 is a schematic sectional depiction of a conventional solenoid valve.

### DESCRIPTION

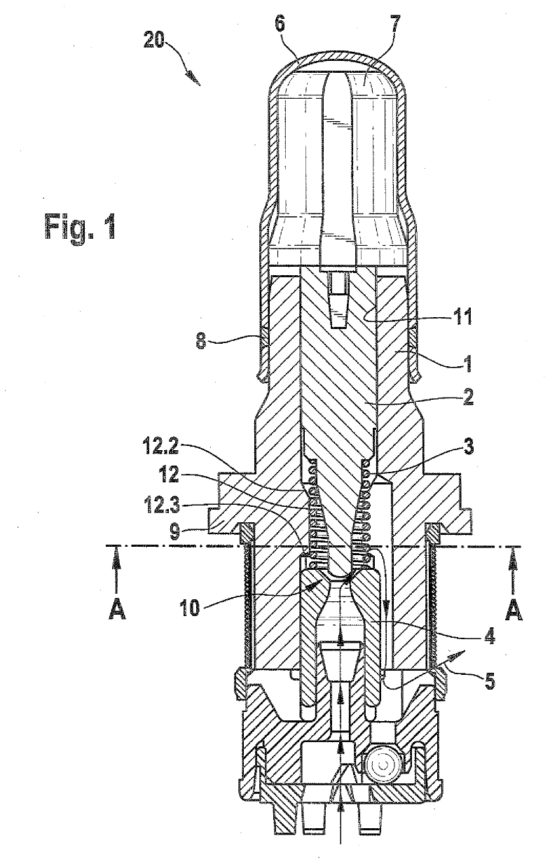

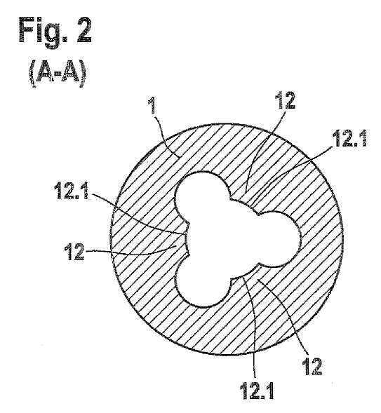

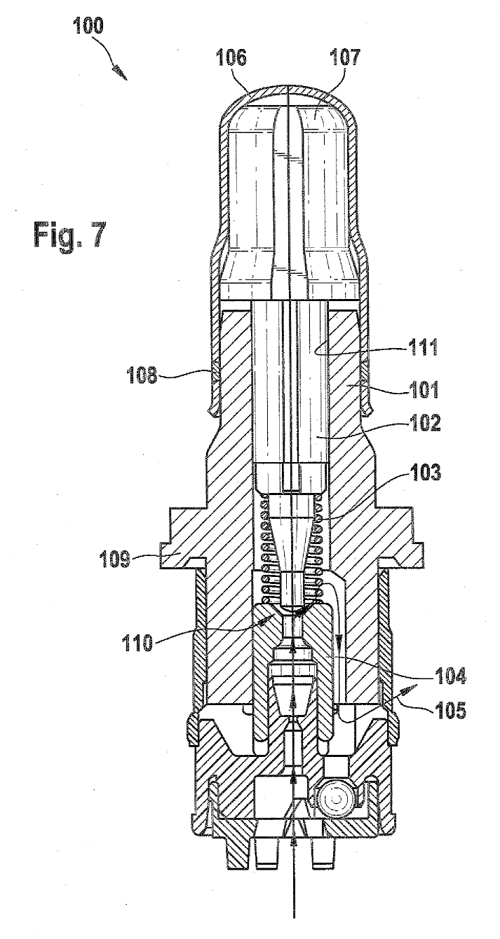

As is clear from FIG. 1, in addition to a magnet assembly that is not shown, a solenoid valve 20 according to the invention has a valve cartridge, which, analogous to the conventional solenoid valve 100 according to FIG. 7, has a capsule 6, a valve insert 1, a tappet 2, a return spring 3, and an armature 7. During the manufacture of the solenoid valve 20, the capsule 6 and the valve insert 1 of the valve cartridge are joined to each other by press-fitting and a sealing weld 8 seals the valve cartridge hydraulically in relation to the atmosphere. In addition, the valve insert 1 absorbs the compressive forces occurring in the hydraulic system and transmits them via a caulking flange 9 to a caulking region, not shown, on a fluid block. In addition, the valve insert 1 accommodates the so-called valve member 4, which includes a valve seat 10 into which the tappet 2 plunges in a sealed fashion in order to perform the sealing function of the solenoid valve 20. As is also clear from FIG. 1, the tappet 2 is guided by means of a tappet guide 11 and the return spring 3 is guided via centering means 12 in the valve insert 1; by contrast with the conventional solenoid valve 100, the return spring 3 is not only centered on the tappet 2 at one end, but is also centered and stabilized by the centering means 12 over virtually its entire length so that the other end of the return spring 3 that rests against the valve member 4 is also centered and stabilized. In the exemplary embodiment shown, in order to center the return spring 3, the centering means 12 of the valve insert 1 has three axially extending centering ribs that are situated inside an internal bore of the valve insert 1 and are preferably spaced apart from one another by an average of 120°, as is clear from the cross-sectional depiction in FIG. 2. In order to facilitate the insertion of the return spring 3, the centering ribs 12 have assembly-assisting insertion bevels 12.2. In addition, the centering ribs are situated in the valve insert 1 so that an underside 12.3 of the centering rib 12 is spaced apart from the valve member 4, thus preventing an impact with the valve member 4 during the assembly process of the solenoid valve 20.

The axial centering means 12 advantageously prevents an undesirable influence on the spring behavior caused by a flow of a fluid—schematically depicted by a sequence of arrows 5—through the solenoid valve 20. It is thus possible, for example, to prevent a lateral break-out of the return spring 3 and/or a lifting of the return spring 3 from the valve member 4 and/or a relative movement or oscillations in the coils of the return spring 3.

Various embodiments of a valve insert 1 will be described below in conjunction with FIGS. 2 through 6. As is clear from FIG. 2, in a first embodiment of the valve insert 1, the three axial centering ribs 12 are adapted to the diameter of the return spring 3 by means of a guide groove 12.1; the guide groove 12.1 is embodied in the form of a segment of a circle. Alternatively, the guides of the axial centering ribs 12 can also be embodied as straight segments. As is also clear from FIG. 2, the axial centering ribs 12 are formed out of the material of the valve insert 1, for example by means of a plurality of bores, for example with the return spring 3 being guided by means of a central bore and conduits for conveying fluid being provided in the form of three additional bores.

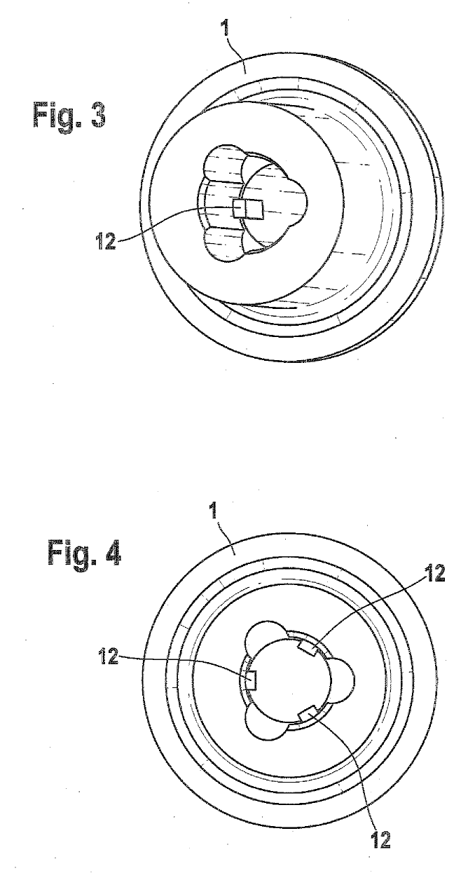

FIGS. 3 and 4 show a second embodiment of the valve insert 1 with three narrow axial centering ribs 12, whose dimensions are adapted to the diameter of the return spring 3. The second embodiment of the valve insert 1 is manufactured, for example, as a cold forged part, which is finished as needed by means of a material-removing process.

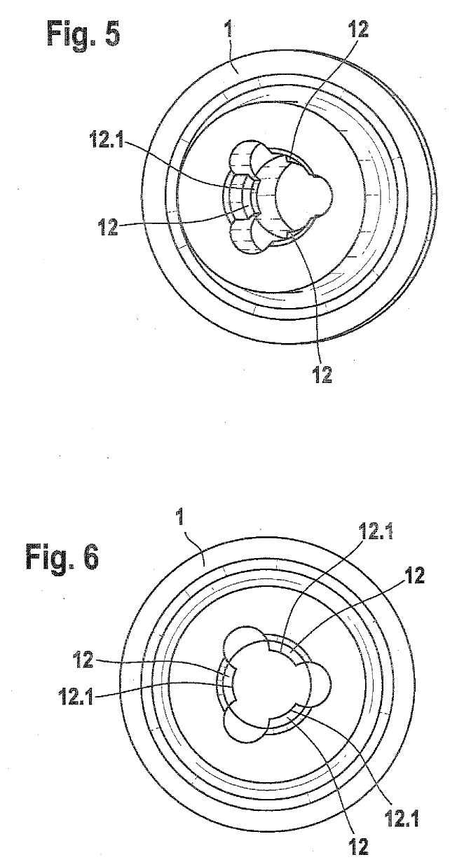

FIGS. 5 and 6 show a third embodiment of the valve insert 1 with three axial centering ribs 12 which, analogous to the first embodiment in FIG. 2, are adapted to the diameter of the return spring 3 by means of a guide groove 12.1. The centering ribs 12 have a cross-sectional form that corresponds to a segment of a circle. The third embodiment of the valve insert 1 is manufactured, for example, as a turned part.

1-8. (canceled)

9. A solenoid valve comprising:
a valve insert;
a tappet disposed inside the valve insert:
a tappet guide movably guiding the tappet inside the valve insert:
a valve member disposed in the valve insert, the tappet being supported against the valve member by means of a return spring; and
a centering means disposed on the valve insert in the region of the return spring for centering and stabilizing the return spring.

10. The solenoid valve as recited in claim 9, wherein the centering means includes at least one axially extending centering rib disposed in an internal bore of the valve insert.

11. The solenoid valve as recited in claim 10, wherein the at least one axial centering rib has a guide groove that is adapted to the diameter of the return spring and whose form preferably corresponds to a segment of a circle.

12. The solenoid valve as recited in claim 9, wherein the centering means is formed from the material of the valve insert.

13. The solenoid valve as recited in claim 10, wherein the centering means is formed from the material of the valve insert.

14. The solenoid valve as recited in claim 11, wherein the centering means is formed from the material of the valve insert.

15. The solenoid valve as recited in claim 9, wherein the valve insert is manufactured with the centering means as a turned part.

16. The solenoid valve as recited in claim 10, wherein the valve insert is manufactured with the centering means as a turned part.

17. The solenoid valve as recited in claim 11, wherein the valve insert is manufactured with the centering means as a turned part.

18. The solenoid valve as recited in claim 13, wherein the valve insert is manufactured with the centering means as a turned part.

19. The solenoid valve as recited in claim 9, wherein the valve insert is manufactured with the centering means as a cold forged part.

20. The solenoid valve as recited in claim 10, wherein the valve insert is manufactured with the centering means as a cold forged part.

21. The solenoid valve as recited in claim 11, wherein the valve insert is manufactured with the centering means as a cold forged part.

22. The solenoid valve as recited in claim 18, wherein the valve insert is manufactured with the centering means as a cold forged part.

23. The solenoid valve as recited in claim 9, wherein the centering means of the valve insert has three axially extending centering ribs that are preferably spaced apart from one another by an average of 120° in order to center the return spring.

24. The solenoid valve as recited in claim 10, wherein the centering means of the valve insert has three axially extending centering ribs that are preferably spaced apart from one another by an average of 120° in order to center the return spring.

25. The solenoid valve as recited in claim 22, wherein the centering means of the valve insert has three axially extending centering ribs that are preferably spaced apart from one another by an average of 120° in order to center the return spring.

26. The solenoid valve as recited in claim 9, wherein the centering means has an assembly-assisting insertion bevel and an underside of the centering means is spaced apart from the valve member.

27. The solenoid valve as recited in claim 10, wherein the centering means has an assembly-assisting insertion bevel and an underside of the centering means is spaced apart from the valve member.

28. The solenoid valve as recited in claim 25, wherein the centering means has an assembly-assisting insertion bevel and an underside of the centering means is spaced apart from the valve member.
